(19) United States
(12) Patent Application Publication
(10) Pub. No.: US 2019/0273852 A1
(43) Pub. Date: Sep. 5, 2019

(54) Camera

(71) Applicant: SICK AG, Waldkirch (DE)

(72) Inventors: Florian SCHNEIDER, Waldkirch (DE); Thomas PFRENGLE, Waldkirch (DE)

(21) Appl. No.: 16/278,442

(22) Filed: Feb. 18, 2019

(30) Foreign Application Priority Data
Mar. 5, 2018 (DE) 102018104906.4

(51) Int. Cl. H04N 5/225; G02B 5/20; G02B 5/30; H04N 5/351

(52) U.S. Cl. CPC H04N 5/2256; G02B 5/20; H04N 5/2254; H04N 5/351; G02B 5/30

(57) ABSTRACT

A camera is provided having an image sensor for generating image data from received light from a detection zone; having a lighting unit having at least one light source for illuminating the detection zone with transmitted light; and having a polarization filter that polarizes the transmitted light and the received light. The polarization filter is configured as an additional module subsequently replaceable from the outside.

The invention relates to a camera, in particular to a code reader, having an image sensor for generating image data from received light from a detection.

Cameras are used in a variety of ways in industrial applications to automatically detect object properties, for example for the inspection or for the measurement of objects. In this respect, images of the object are recorded and are evaluated in accordance with the object by image processing methods. A further use of cameras is the reading of codes. Objects with the codes located thereon are recorded using an image sensor and the code regions are identified in the images and then decoded. Camera-based code readers also cope without problem with different code types than one-dimensional barcodes which also have a two-dimensional structure like a matrix code and provide more information. The automatic detection of the text of printed addresses (optical character recognition, OCR) or of handwriting is also a reading of codes in principle. Typical areas of use of code readers are supermarket cash registers, automatic parcel identification, sorting of mail shipments, baggage handling at airports, and other logistic applications.

A frequent detection situation is the installation of the camera above a conveyor belt. The camera records images during the relative movement of the object stream on the conveyor belt and instigates further processing steps in dependence on the object properties acquired. Such processing steps comprise, for example, the further processing adapted to the specific object at a machine which acts on the conveyed objects or a change to the object stream in that specific objects are expelled from the object stream within the framework of a quality control or the object stream is sorted into a plurality of partial object streams. If the camera is a camera-based code reader, the objects are identified with reference to the affixed codes for a correct sorting or for similar processing steps.

Many industrial camera systems use their own lighting to be independent of variable light conditions. Polarized light is used for a better coping with shiny or reflective objects. The transmission and reception paths are here each provided with a linear polarization filter. The orientation of the two polarization filters is rotated by 90°. With industrial cameras, the polarization filters are fixedly installed in the camera system. A subsequent installation or replacement is at best possible if the device is dismantled for this purpose and if a hood of the camera protecting the front is unscrewed.

A barcode scanner is known from DE 10 2010 014 783 A1 in whose optical path for the transmitted and received light beams a thin film polarization filter is arranged.

U.S. Pat. No. 9,033,237 B1 discloses a hand-held device for reading imparted codes (DPM, direct part marking). Such codes are read at a very shallow angle of incidence of the lighting that is accordingly at some distance from and at an oblique alignment to the image sensor. A respective polarization filter is arranged in the transmission and reception optical path.

A code reader is presented in U.S. Pat. No. 9,542,583 B2 that comprises a polarized light source and a non-polarized light source so that a suitable lighting can be selected as required.

WO 2015/019370 A1 deals with a further barcode scanner having polarization filters, wherein the polarization filters of the light transmitter polarizes a portion of the laser beam and is permeable for a further portion of the laser beam.

A replacement of the polarization filter is not provided in any of these conventional apparatus.

Polarization filters are furthermore known for cameras that are placed onto the objective. This then, however, only relates to the reception optical path.

It is therefore the object of the invention to improve detection by a camera.

This object is satisfied by a camera in accordance with claim 1. The camera generates image data from received light using an image sensor. A lighting unit having at least one light source illuminates the detection zone of the camera for this purpose. A polarization filter polarizes transmitted light and received light. The polarization filter is preferably configured to generate a linear polarization, and indeed for received light and transmitted light offset by 90° with respect to one another.

The invention now starts from the basic idea of subsequently replacing the polarization filter. The term replacement should here equally comprise the addition or removal, that is a conversion from polarized light to non-polarized light, and vice versa, and a change to a different polarization filter or a different installation of the previously already installed polarization filter to obtain differently polarized light. To substantially simplify the replacement or to make it possible at all, the polarization filter is configured as an additional module subsequently replaceable from outside.

The invention has the advantage that a fast, flexible adaptation to new demands or to new applications is possible due to the replacement. The exchange takes place very quickly, without tools, and no special qualification is required for it.

The polarization filter is preferably configured as a plug-on module having a snap connection. Snap hooks are, for example, provided at the plug-on module for this purpose. The camera or its housing can have matching receivers at its front, can have an overhang, or can have a groove for hooking in, However, it can preferably not be seen from the design of the camera without an additional module that an additional module can be attached. The retrofitting for polarized light by the additional module is then possible completely subsequently and fully optionally.

The polarization filter is preferably configured as a plug-on module having a magnetic connection. For this purpose, magnets can be provided at the additional module and at the camera or magnets are only located at one side, while the other side comprises a magnetic material. Particularly preferably, the magnets are on sides of the additional module since then the camera only requires corresponding metallic regions at the front side of its housing, which is also frequently the case without a special design for the additional module.

The polarization filter is preferably arranged in front of a front screen of the camera. The camera therefore does not have to be modified or opened at all to attach the additional module. The additional module alternatively itself has the front screen. Both orders with a polarization filter at the inside and a front screen at the outside, or vice versa, are then conceivable here. In addition, it is conceivable to integrate the polarization filter into the front screen. The front screen is replaced with the additional module to attach such an additional module. If the front screen can already be fastened without tools, for example by a snap-in or magnetic mechanism, it is possible very quickly and without problem.

The additional module preferably has an exchangeable frame that terminates a housing of the camera toward its front side. The exchangeable frame is seated toward the camera on a housing and/or on a circuit board of the camera. Toward the outside, the front screen on the exchangeable frame closes the camera, with an opening for a reception objective being able to remain. The polarization filter is at the inside or at the outside at the exchangeable frame depending on the embodiment with the positions within and outside the front screen and integrated therein being possible for the polarization filter. The exchangeable frame preferably surrounds the light sources of the lighting unit.

The additional module is preferably rectangular. It is thus particularly suitable for a substantially parallelepiped-shaped camera that uses its frontal, rectangular side in total or at least largely for a front screen having a light outlet of the lighting unit or further lighting devices, for instance, for a target apparatus or for an illuminated display or a projected user feedback. An additional module having an exchangeable frame then forms the rectangular front side.

The lighting unit preferably has a plurality of separately controllable groups of light sources. Each of the groups of preferably equal size comprises at least one light source. By a direct activation or intensity adaptation of the groups, different lighting scenarios are created that can be predefined by parameters, but can also be set or taught by feedback of an evaluation of the image data. Four groups are preferably provided per edge or corner of a deflection element formed as a rectangular frame. The lighting then becomes changeable from all four directions by an individual control of the groups.

The light sources of one group preferably have a different color than the light sources of a different group. There are therefore at least two groups of light sources and at least two colors. However. more groups and more colors are also possible, with not all groups having to have different colors. Some structures, in particular codes of specific colors on a specific background, can be read better in a matching lighting spectrum. This can be achieved by setting a color for the light sources, but also by mixing colors. Depending on the embodiment, light sources of different colors or light sources whose color can be switched such as multicolor LEDs can be provided.

The additional module is preferably formed with a first surface for polarizing the transmitted light and a second surface for polarizing the received light. The direction of polarization of the two surfaces is preferably rotated by 90° against the other. This has the effect that gloss reflections are practically not detected without a polarization rotation. The two surfaces are preferably disposed in the same plane. A very compact assembly is thereby possible.

The additional module preferably has a surface for the passage of transmitted light without polarization. This is useful, on the one hand, if a plurality of light sources or groups of light sources are separately controllable. Corresponding transmitted light is directly generated by activating light sources correspondingly arranged at a polarizing or non-polarizing surface of the additional module. With multicolor light sources, the color or a combination of color and polarization can also be selected. A further surface is also conceivable that polarizes transmitted light, but with a different direction of polarization than the first surface. It can then be selected whether gloss reflections are exclusively transmitted on an agreement of the directions of polarization at the transmission side and at the reception side or whether they are directly filtered with a displacement by 90°. On the other hand, the selection of the transmitted light cannot take place by controlling specific light sources, but rather by a specific arrangement of the additional module with respect to the light sources.

The additional module is preferably attachable to the camera at different orientations. A rotation by 180°, depending on the shape of the camera and of the additional module, also by 90° or a different angle, can in particular be considered here. The polarization filters are then preferably actually not arranged correspondingly rotationally symmetrically in the additional module. A selection can be made via the orientation of the additional module on its attachment as to which light sources are polarized and which are not, or a specific direction of polarization is fixed in this manner.

The camera preferably has a presence sensor to recognize whether an additional module is arranged in the optical path of the camera. The presence sensor can also deliver the information as to which additional module is plugged on or which polarizations and directions of polarization the additional module generates. The presence sensor is, for example, set up on the basis of at least one Hall sensor or of an inductive sensor that recognizes the frame of the polarization filter. A kind of simple coding to distinguish different additional modules and/or orientations can be specified by multiple arrangements and materials or material thicknesses. The presence sensor provides the possibility of adapting controls such as a power of the light transmitter, an exposure time, or a sensitivity of the image sensor directly and automatically to the additional module. In addition, a query can be instigated by a higher ranking system as to which configuration of the camera with its currently detected additional module is present.

The camera preferably has a control and evaluation unit that is configured to identify code regions in the image data and to read their code content. The camera thus becomes a camera-based code reader for barcodes and/or 2D codes according to various standards, optionally also for optical character recognition (OCR). A control and evaluation unit is provided in another respect preferably without a code reading function that controls and performs the various tasks in the camera such as the image recording, a lighting, the measurement of actual and required focal positions and their display.

The invention will be explained in more detail in the following also with respect to further features and advantages by way of example with reference to embodiments and to the enclosed drawing. The Figures of the drawing show in:

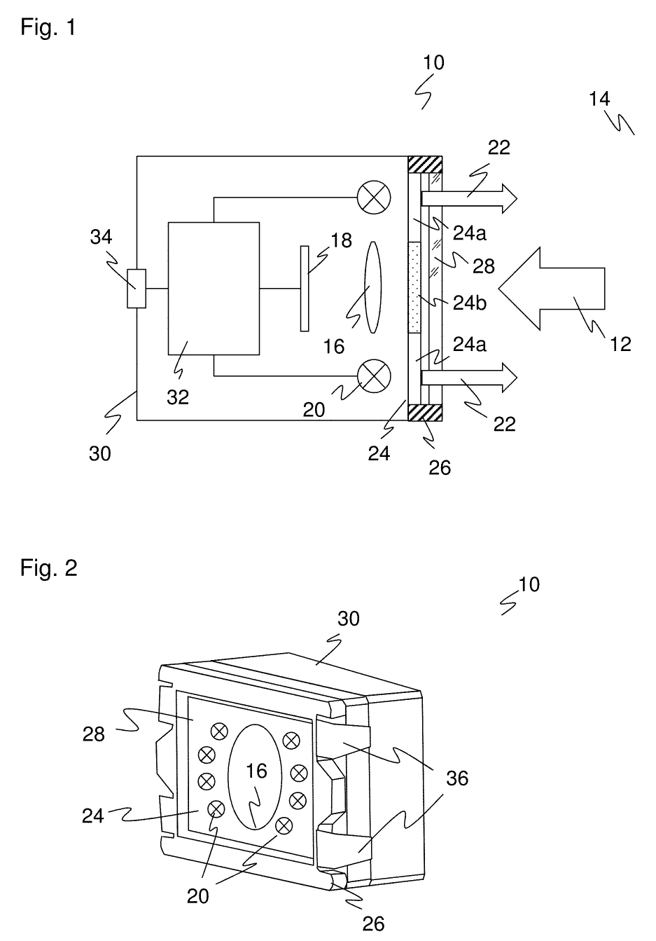

FIG. 1 a schematic sectional representation of a camera with lighting;

FIG. 2 a three-dimensional view of a camera having an additional module that is attached by a snap-in mechanism;

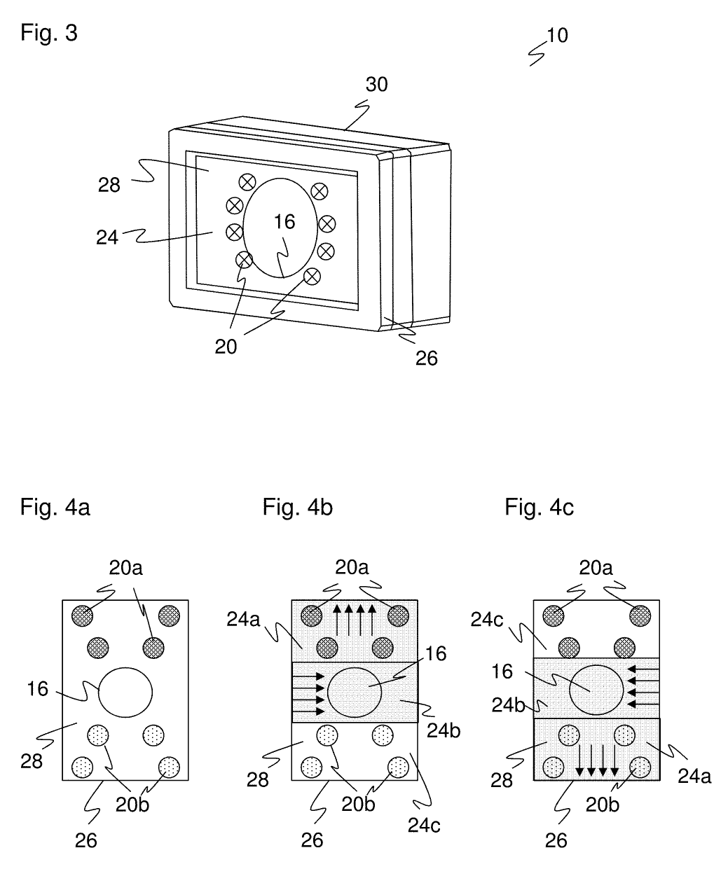

FIG. 3 a three-dimensional view of a camera having an additional module that is attached by a magnetic mechanism;

FIG. 4a a frontal view of a camera without a plugged-on additional module;

FIG. 4b a frontal view of a camera having a plugged-on additional module;

FIG. 4c a frontal view of a camera having a plugged-on additional module rotated by 180° with respect to FIG. 4b;

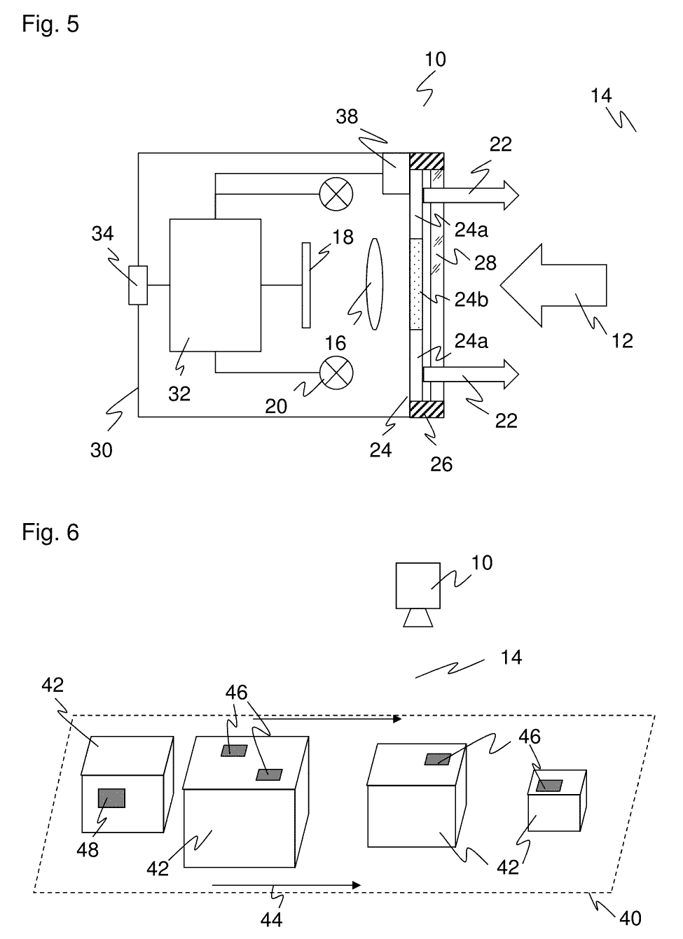

FIG. 5 a schematic sectional representation of a camera having a presence sensor for an additional module; and

FIG. 6 a three-dimensional view of an exemplary use of the camera in an installation at a conveyor belt.

FIG. 1 shows a schematic sectional representation of a camera 10. Received light 12 from a detection zone 14 is incident on a reception optics 16 that conducts the received light 12 to an image sensor 18. The optical elements of the reception optics 16 are preferably configured as an objective composed of a plurality of lenses and other optical elements such as diaphragms, prisms, and the like, but here only represented by a lens for reasons of simplicity.

To illuminate the detection zone 14 during a recording of the camera 10, the camera 10 comprises a lighting unit that is shown in FIG. 1 in the form of two light sources 20, for example LEDs or also laser diodes. The lighting unit generates transmitted light 22 that is transmitted into the detection zone 14. A transmission optics, not shown, can be associated with the light sources 20 to influence the transmitted light 22 in a desired manner.

A polarization filter 24 is arranged in the camera 10 in the outlet region of the transmitted light 22 and in the inlet region of the received light. The polarization filter 24 has first surface 24a for polarizing the transmitted light 22 and a second surface 24b for polarizing the received light 12. The two surfaces 24a-b are preferably configured with a mutual displacement of 90° for a linear polarization.

The polarization filter 24 is arranged in a plug-on frame 26 that additionally holds a front screen 28 of the camera 10. A front side of a housing 30 of the camera is closed in this manner. The plug-on frame 26 having the polarization filter 24 and the front screen 28 forms a plug-on module or additional module by which the polarization properties of the camera 10 are subsequently varied. There are a plurality of possibilities for this: changing between an operation with polarization and without polarization by using an additional module as shown or by using a plug-on frame 26 only having the front screen 28; changing the polarization properties by replacement with an additional module having a different polarization filter 24, or plugging on the additional module in a different arrangement, in particular rotated by 180° about the optical axis of the reception optics 16.

The polarization filter 24 is arranged internally behind the front screen 28 in FIG. 1. A swapped-over order with a polarization filter outside is alternatively also possible. In a further embodiment, the polarization filter 24 is integrated in or directly connected to the front screen 28 or acts as a front screen 28.

A control and evaluation unit 32 is connected to the lighting unit and to the image sensor and is responsible for the control work, the evaluation work, and for other coordination work in the camera 10. It therefore reads image data of the image sensor 18 to process them and to output them at an interface 34. Separate evaluations of the image data are also conceivable, in particular the decoding of code regions in the image data so that the camera 10 becomes a camera-based code reader.

FIG. 2 shows a three-dimensional view of a camera 10 having an additional module that is plugged onto the camera 10 by a snap-in mechanism. The camera 10 has a rectangular front, with variations such as rounded corners remaining possible. The plug-on frame 26 and the front screen 28 are adapted to the rectangular shape. As can be recognized, a very flat frontal region is possible for the lighting unit and for the polarization filter 24 and, depending on the complexity of the reception optics 16 and of the electronics, for instance the control and evaluation unit 32, also an overall very flat device structure such as shown or with an even smaller depth.

The additional module or the plug-on frame 26 in the embodiment in accordance with FIG. 2 has a plurality of snap hooks 36, four by way of example here, that snap in at the housing 30. A groove, an overhang, or the like can be provided there to give the snap hook 36 a better grip. The snap hooks 36 provide a stable position of the additional module and are nevertheless releasable without tools at any time to remove the additional module or to attach a different additional module.

FIG. 3 shows a three-dimensional view of a camera 10 having an additional module that is attached to the camera 10 by a magnetic holder. In this magnetic fastening concept, a hard magnetic material is located at the camera 10 or at the plug-on frame 26. The counter-side is designed either with a soft magnetic material or with a hard magnetic material. Active magnets are preferably only provided at the plug-on frame 26, while the housing 30 only has magnetic material in the provided contact region. The camera 10 then namely does not have to be further modified at all if its housing 30 includes sufficient magnetic metal.

FIGS. 2 and 3 show two examples for a very simple replacement mechanism of the additional module without tools. There are further possibilities for this, for instance hooks engaging internally in openings or a peripheral margin of the plug-on frame 26 snapping onto the front side of the housing 30. The examples shown are therefore not exclusive. In principle, the plug-on frame 26 can also be fixed by one or more screws. This is always simpler than the conventional design because the polarization filter 24 is also very easily accessible from the outside when screws are used without having to remove further parts. Screws can, however, primarily be considered on a particular mechanical stress due to shaking or vibrating and such conditions must as a rule anyway be avoided for a camera 10. The preferred principle of the replacement of the additional module is without tools and thus in particular without screws.

FIGS. 4a-c show a frontal view of the camera 10. In FIG. 4a, no additional module is plugged on; in FIG. 4b, an additional module having a polarization filter 24 having three surfaces 24a-c; and in FIG. 4c, the additional module in accordance with FIG. 4b rotated by 180°. The plug-on frame 26 is therefore advantageously configured such that a fastening rotated by 180° is also possible.

In the embodiment shown, light sources 20a-b of different colors are used such as indicated by hatching; for example red and blue. It is alternatively possible to already enable a plurality of colors within a respective light source 20a-b such as with a multi-color LED or light sources 20a-b of different colors are used next to one another that are selectively activated for specific colors. Some structures become more easily recognizable due to a color change; for instance codes are read better in a red or in a blue light depending on the print color and the background.

The light sources 20a-b are preferably separately controllable and thereby enable variable lighting zones. To reduce the circuit complexity, it can be sufficient only to control groups of light sources 20a-b together. In the embodiment shown, the respective light sources 20a-b of the same color can each form one of two groups. More groups or different groups are equally conceivable, for instance four groups in accordance with the sectors, an inner group and an outer group, and the like. In this manner, a lighting from specific directions can be directly generated, in particular in an interplay with an image processing of the image data of the image sensor 18 in the control and evaluation unit 32 in order in this manner to find the best possible lighting setting for the respective application.

In the configuration in accordance with FIG. 4a, no additional module having a polarization filter 24 is attached; for example a plug-on frame only having the front screen 28. The camera 10 consequently works with non-polarized transmitted light 22 and received light 12. Different colors and/or lighting zones remain possible.

In the configuration in accordance with FIG. 4b, an additional module having a polarization filter is plugged on that has a first surface 24a having a linear polarization in a first direction for the transmitted light 22 of the light sources 20a, here by way of example upward; a second surface 24b having a linear polarization rotated by 90° for the received light 12, here by way of example downward; and a third surface 24c without polarization for the transmitted light 22 of the light sources 20b. It is then possible to record images with or without polarized transmitted light by activating the upper light sources 20a or the lower light sources 20b. The colors of the light sources 20a-b can here naturally be differently distributed or only light sources 20a-b of one color can be used so that the selection of the polarization is not bound to the selection of the color. The configuration of the polarization filter 24 is anyway only an advantageous example. More surfaces can be provided, in particular each having different directions of polarization to also make them selectable, and conversely only a single polarizing surface for all the light sources 20a-b in which then the second surface 24b for the received light 12 is centrally located.

By dividing the polarization filter 24 into surfaces 24a-c having different polarization properties and by controlling specific groups of light sources 20a-b, lighting zones and polarization properties can thus be selected without further conversion and with a different additional module. In combination with light sources 20a-b of a plurality of colors, polarization properties and/or a lighting spectrum can be matched in operation.

If the variability by one and the same additional module is not sufficient, it can be replaced with a different additional module that brings along the desired properties. The configuration in accordance with FIG. 4c illustrates a particularly advantageous embodiment for this. No new additional module is plugged on here, but the additional module of FIG. 4b is rather rotated by 180°. The transmitted light 22 of the upper light sources 20a is then transmitted without polarization by the surface 24c with swapped over roles and the transmitted light 22 of the lower light sources 20b is linearly polarized by the surface 20a. The change of the direction of rotation by 180° that occurs here does not play any role; on the one hand because the direction of polarization of the received light 12 also rotates accordingly, and above all because only the relative rotation of the direction of polarization by 90° between the transmitted light 22 and the received light 12 is important.

FIG. 5 shows a schematic sectional representation of a further embodiment of the camera 10. Unlike FIG. 1, an additional presence sensor 38 is provided here that recognizes whether a plug-on frame 26 having a polarization filter 24 is plugged on or not. The presence sensor 38 is only shown purely schematically and is, for example, built up of one or more Hall sensors or inductive sensors that recognize a corresponding magnetized or metallic plug-on frame 26. By detection at a plurality of points and a corresponding configuration of material and geometry of the plug-on frame 26 at the corresponding points, a kind of simple code can be created by modified presence signals by which code different plug-on frames 26 and thus polarization filters 24 are distinguished. Such a differentiated presence detection can also distinguish different orientations such as were explained with reference to FIG. 4.

The identification of the respective polarization filter 24 or the recognition that no polarization filter 24 is plugged on enables an automatic, direct adaptation of camera parameters. Examples for such settings of the camera 10 are the brightness of the light sources 20 or the sensitivity (gain) of the image sensor 18. This is additionally useful when the camera 10 is integrated in a higher ranking system. It can be important to know the current configuration of the camera 10 and to query the presence sensor 38 for it for maintenance over the internet or for remote data transmission and data evaluation, in particular in a cloud or in a different network.

FIG. 6 shows a possible use of the camera 10 in installation at a conveyor belt 40 that conveys objects 42, as indicated by the arrow 44, through the detection zone 14 of the camera 10. The objects 42 can bear code regions 46 at their outer surfaces. It is the object of the camera 10 to detect properties of the objects 42 and, in a preferred use as a code reader, to recognize the code regions 46, to read and decode the codes affixed there, and to associate them with the respective associated object 42. In order also to recognize laterally applied code regions 48, additional cameras 10, not shown, are preferably used from different perspectives.

1. A camera comprising:
an image sensor for generating image data from received light from a detection zone;
a lighting unit having at least one light source for illuminating the detection zone with transmitted light; and
a polarization filter that polarizes the transmitted light and the received light,
wherein the polarization filter is configured as an additional module subsequently replaceable from the outside.

2. The camera in accordance with claim 1,
wherein the camera is a code reader.

3. The camera in accordance with claim 1,
wherein the polarization filter is configured as a plug-on module having a snap connection.

4. The camera in accordance with claim 1,
wherein the polarization filter is configured as a plug-on module having a magnetic connection.

5. The camera in accordance with claim 1,
wherein the polarization filter is arranged in front of a front screen of the camera.

6. The camera in accordance with claim 1,
wherein the additional module has the front screen.

7. The camera in accordance with claim 1,
wherein the additional module has a changeable frame that terminates a housing of the camera toward its front side.

8. The camera in accordance with claim 1,
wherein the additional module is rectangular.

9. The camera in accordance with claim 1,
wherein the lighting unit has a plurality of separately controllable groups of light sources.

10. The camera in accordance with claim 9,
wherein the light sources of one group have a different color than the light sources of a different group.

11. The camera in accordance with claim 1,
wherein the additional module is configured with a first surface for polarizing the transmitted light and with a second surface for polarizing the received light.

12. The camera in accordance with claim 11,
wherein the additional module has a surface for the passage of transmitted light without polarization.

13. The camera in accordance with claim 1,
wherein the additional module can be attached to the camera in different orientations.

14. The camera in accordance with claim 1,
further comprising a presence sensor for recognizing whether an additional module is arranged in the optical path of the camera.

15. The camera in accordance with claim 1,
further comprising a control and evaluation unit that is configured to identify code regions in the image data and to read their code content.
